(19) United States
(12) Patent Application Publication
(10) Pub. No.: US 2015/0353161 A1
(43) Pub. Date: Dec. 10, 2015

(54) Mountain Bike Handlebar Grip

(71) Applicant: Paul Nicholas Chait, San Rafael, CA (US)

(72) Inventor: Paul Nicholas Chait, San Rafael, CA (US)

(21) Appl. No.: 14/731,084

(22) Filed: Jun. 4, 2015

Related U.S. Application Data
(60) Provisional application No. 62/007,688, filed on Jun. 4, 2014.

(51) Int. Cl. B62K 21/26

(52) U.S. Cl. CPC B62K 21/26

(57) ABSTRACT

A handlebar grip which incorporates a hinge in or near the outboard end of the grip allowing a substantial portion of the grip to flip up from the grip body to become the equivalent of a hard-mounted bar end, but with the ability to easily flip back down flush with or adjacent to the grip body and out of harm's way when riding in tight quarters. The bar ends can be deployed when riding uphill providing all the advantages of bar ends, and just as easily flipped closed when riding downhill so that they do not interfere with nearby obstacles. In addition, by incorporating the inventive bar end feature into the grip itself, the bicycle controls do not have to be moved inboard on the handlebar, and nothing protrudes past the end of the handlebar.

### CROSS REFERENCE TO RELATED APPLICATIONS

The present application claims the benefit of the filing date of U.S. Provisional Patent Application Ser. No. 62/007,688, filed Jun. 4, 2014. The foregoing application is incorporated by reference in its entirety as if fully set forth herein.

### STATEMENT REGARDING FEDERALLY SPONSORED RESEARCH OR DEVELOPMENT

Not applicable.

### REFERENCE TO A MICROFICHE APPENDIX

Not applicable.

### TECHNICAL FIELD

The present invention relates generally to bicycles and bicycle components, and more particularly to an improved handlebar grip for mountain bikes and the like.

### BACKGROUND INFORMATION AND DISCUSSION OF RELATED ART

Devices commonly known as “bar ends” are often mounted to the ends of a mountain bike handlebar to assist the rider when pedaling uphill. The alternate hand position provided by bar ends is more than just ergonomic. By holding on to what is in essence a lever mounted to each end of the handlebar, the rider's upper body is able to work in conjunction with the legs to provide more power to the pedals when climbing. This advantage is widely known.

The major disadvantage of having bar ends mounted to the handlebar is equally well known; when riding near anything the bar end can grab onto, a fall usually occurs. Bar ends can act like hooks and if they catch even a small tree branch or vine the rider will be pitched off the bike.

Furthermore, conventional bar ends take up approximately ¾″ to 1″ of space on each end of the handlebar and require that the bicycle controls (e.g., brake levers, shifters and grips) be moved inboard by this amount resulting in a hand position that is unfavorably closer together. These disadvantages, in conjunction with the trend toward wider handlebars which increase the likelihood of hooking something while riding, have caused the use of bar ends to fall out of favor.

The foregoing information reflects the current state of the art of which the present inventor is aware. Reference to, and discussion of, this information is intended to aid in discharging Applicant's acknowledged duty of candor in disclosing information that may be relevant to the examination of claims to the present invention. However, it is respectfully submitted that none of the above-indicated information discloses, teaches, suggests, shows, or otherwise renders obvious, either singly or when considered in combination, the invention described and claimed herein.

### SUMMARY OF THE INVENTION

The mountain bike handlebar grip of the present invention provides a handlebar grip which incorporates a hinge in or near the outboard end of the grip allowing a substantial portion of the grip to flip up from the grip body to become the equivalent of a hard-mounted bar end, but with the ability to easily flip back down flush with or adjacent to the grip body and out of harm's way when riding in tight quarters. A benefit of the inventive grips is that they can be deployed when riding uphill providing all the advantages of bar ends, and just as easily flipped closed when riding downhill so that they do not interfere with nearby obstacles that could grab them. In addition, by incorporating the inventive bar end feature into the grip itself, the bicycle controls (e.g., brake levers, shifters and grips) do not have to be moved inboard on the handlebar, and nothing protrudes past the end of the handlebar.

It is therefore an object of the present invention to provide a new and improved handlebar grip for mountain bikes and the like.

It is another object of the present invention to provide a new and improved handlebar grip that provides the benefit of bar ends.

A further object or feature of the present invention is a new and improved handlebar grip that does not catch onto nearby obstacles.

An even further object of the present invention is to provide a novel handlebar grip that does not require relocation of the bicycle controls.

Other novel features which are characteristic of the invention, as to organization and method of operation, together with further objects and advantages thereof will be better understood from the following description considered in connection with the accompanying drawings, in which preferred embodiments of the invention are illustrated by way of example. It is to be expressly understood, however, that the drawings are for illustration and description only and are not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

There has thus been broadly outlined the more important features of the invention in order that the detailed description thereof that follows may be better understood, and in order that the present contribution to the art may be better appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Further, the purpose of the Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of this application, which is measured by the claims, nor is it intended to be limiting as to the scope of the invention in any way.

Certain terminology and derivations thereof may be used in the following description for convenience in reference only, and will not be limiting. For example, words such as “upward,” “downward,” “left,” and “right” would refer to directions in the drawings to which reference is made unless otherwise stated. Similarly, words such as “inward” and “outward” would refer to directions toward and away from, respectively, the geometric center of a device or area and designated parts thereof. References in the singular tense include the plural, and vice versa, unless otherwise noted.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a view of a pair of mountain bike handlebar grips of the present invention as mounted on a handlebar, illustrating the bar end portions of the grips in their retracted positions; and

FIG. 2 is a view of the pair of mountain bike handlebar grips of FIG. 1, illustrating the bar end portions of the grips in their extended positions.

### DETAILED DESCRIPTION OF THE INVENTION

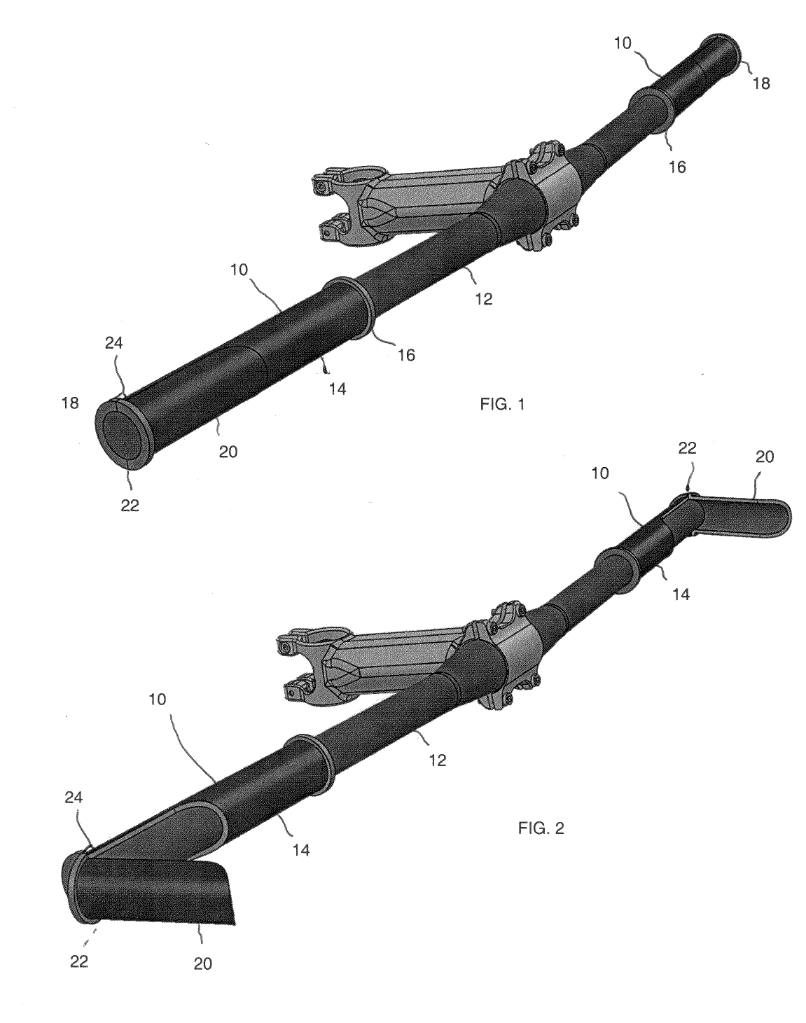

Referring to FIGS. 1 and 2, wherein like reference numerals refer to like components in the various views, there is illustrated therein a new and improved mountain bike handlebar grip, generally denominated 10 herein.

FIG. 1 is a view of a pair of mountain bike handlebar grips 10 as mounted on both the left and right sides of a handlebar 12. Each grip 10 is preferably in the form of a generally hollow cylinder slidable over the ends of the handlebar, and each preferably includes a grip sleeve 14, inner clamp 16, outer clamp 18, and bar end portion 20 (shown in its retracted position) connected to the outboard end of the grip sleeve by hinge 22. Hinge 22 may be constructed as an integral part of the outer clamp as illustrated, or as a separate structure adjacent the outer clamp (e.g., radially outward of the outer clamp, or laterally inboard or outboard of the outer clamp). Having both inner and outer clamps is not necessary to the invention but is preferred, as the grips each having an inner and outer clamping mechanism connected to a common sleeve shares the load imparted by the rider and eliminates the need to excessively tighten the clamps which could damage thin-walled handlebars.

FIG. 2 is a view of the pair of mountain bike handlebar grips 10, illustrating the bar end portions 20 of the grips in their extended positions, preferably generally perpendicular to the grip sleeves. Bar end portion 20 may be in the form of a semi-cylindrical portion of the grip sleeve 14 as illustrated, or a separate semi-cylindrical piece overlying the grip sleeve, of a size to provide a suitable bar end for grasping by the rider's hands when extended. The grip clamps can be installed onto the handlebar and tightened in a position such that when the bar end portions are deployed they are most comfortable for the rider, usually oriented at an approximately 45 degree angle forward. The bar end portions 20 may be designed to flip open and lock into place when extended, and to close, the rider simply presses a release button or latch 24 on each grip (as easily as with one finger, and without taking hands off the handlebars) to enable moving the bar end portions back to their retracted position.

Accordingly, the inventive grip may be characterized as a grip for a bicycle handlebar, comprising a generally hollow cylinder including a grip sleeve and a bar end portion connected to an outboard end of the grip sleeve by a hinge, wherein the bar end portion can be selectively extended outward generally perpendicular to the grip sleeve to provide a bar end, and returned to a retracted position generally flush with the grip sleeve.

The above disclosure is sufficient to enable one of ordinary skill in the art to practice the invention, and provides the best mode of practicing the invention presently contemplated by the inventor. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or the like. Therefore, the above description and illustrations should not be construed as limiting the scope of the invention, which is defined by the appended claims.

What is claimed as invention is:

1. A grip for a bicycle handlebar, said grip comprising:
a generally hollow cylinder including a grip sleeve and a bar end portion connected to an outboard end of said grip sleeve by a hinge, wherein said bar end portion can be selectively extended outward generally perpendicular to said grip sleeve to provide a bar end, and returned to a retracted position generally flush with said grip sleeve.

2. The grip for a bicycle handlebar of claim 1 wherein said grip sleeve includes an inner clamp.

3. The grip for a bicycle handlebar of claim 1 wherein said grip sleeve includes an outer clamp.

4. The grip for a bicycle handlebar of claim 1 wherein said grip sleeve includes an inner clamp and an outer clamp.

5. The grip for a bicycle handlebar of claim 1 wherein said hinge is constructed as an integral part of said outer clamp.

6. The grip for a bicycle handlebar of claim 1 wherein said bar end portion is a semi-cylindrical portion of said grip sleeve, of a size to provide a suitable bar end for grasping by a rider's hand when said bar end portion is extended.

7. The grip for a bicycle handlebar of claim 1 wherein said bar end portion locks into place when extended.

8. The grip for a bicycle handlebar of claim 7 wherein said grip includes a release button to enable moving said bar end portion back to a retracted position.
